(19) United States
(12) Patent Application Publication
(10) Pub. No.: US 2009/0039757 A1
(43) Pub. Date: Feb. 12, 2009

(54) Excimer Lamp

(76) Inventors: Hiroyoshi Ohshima, Saitama (JP); Norio Kobayashi, Saitama (JP)

Correspondence Address: NIXON & VANDERHYE, PC, 901 NORTH GLEBE ROAD, 11TH FLOOR, ARLINGTON, VA, 22203, US

(21) Appl. No.: 11/918,870

(22) PCT Filed: Mar. 28, 2006
(86) PCT No.: PCT/JP2006/307025

§ 371 Date: Nov. 13, 2007

(30) Foreign Application Priority Data
Apr. 22, 2005 (JP) 2005-124367
Feb. 28, 2006 (JP) 2006-052812

(51) Int. Cl. H01J 63/04

(52) U.S. Cl. 313/484

(57) ABSTRACT

The present invention seeks to provide an excimer lamp enhanced in the radiation output of excimer rays, the excimer lamp having at least an optical radiation window provided on the exit side of radiation of rays and a plurality of excimer discharge plates electrodes opposed to one another and having a constitution in which excimer discharge gas present in discharge spaces formed in the said opposed electrodes causes a discharge to radiate excimer rays, said excimer discharge electrodes being flat-plate electrodes, a plurality of said discharge spaces being provided, each of which is between flat-plate electrodes, said optical radiation window being provided in parallel with discharge channels of said discharge spaces.

### TECHNICAL FIELD

The present invention relates to an excimer lamp that radiates excimer ray.

### BACKGROUND ART

For curing a coating composition or for carrying out surface washing or surface modification of a semiconductor wafer, a glass substrate, etc., it is conventional practice to radiate excimer rays to an object to be treated, by means of an excimer lamp.

As a method for applying excimer rays, a method using dielectric barrier discharge is known, and as the above excimer lamp, there is known an excimer lamp that is described in JP-A-2001-135279.

In the excimer lamp described in JP-A-2001-135279, a nearly co-axial dual circular tube is formed by co-axially arranging hollow quartz glass tubes having different diameters in cross section, a gas for excimer discharge is filled in a hollow portion formed between the two quartz glass tubes, an external electrode is wound around the outer surface of the outer-side quartz glass tube, an internal electrode is wound around the outer surface of the inner-side quartz glass tube (surface on the central axis side of the tube), and a high-frequency voltage is applied between these two electrodes to perform capacity, coupling type discharge.

As a literature that discloses an excimer lamp using dielectric barrier discharge, there can be referred to “Studies on an excimer lamp as a new UV source” by Kamibayashi Masanori and four other researchers, in preprints of No. 5 Annual Study Conference of Japan Ozone Association in the year of 1996. FIG. 5 of this literature discloses that, in an excimer lamp according to a surface discharge method, the radiation intensity of the excimer lamp is increased by increasing the pressure of discharge gas filled in a discharge chamber.

### DISCLOSURE OF THE INVENTION

JP-A-2001-135279 describes an excimer lamp apparatus having a constitution in which a plurality of casings are arranged, at least one excimer lamp above being provided in each casing, excimer rays are radiated from longitudinal-direction surfaces of the excimer lamps and excimer rays are outputted through those side surfaces of the casings which are in the longitudinal direction of the excimer lamps.

However, the excimer lamp apparatus described in the above JP-A-2001-135279 is intended to attain a higher output by using a plurality of excimer lamps, and it has a problem that the outputs from the individual excimer lamps thereof are not necessarily sufficient.

Further, the excimer lamp disclosed in “the preprints of No. 5 Annual Study Conference of Japan Ozone Association in the year of 1996” is according to a surface discharge method. The present inventors have made studies thereof and found the following. In a luminous unit having discharge chambers formed of a dielectric material such as quartz, etc., and alternately arranged with electrodes, when a high-frequency voltage is applied to a discharge gas filled in the discharge chambers to cause a discharge, the discharge chambers are sometimes cracked or broken when the pressure of the discharge gas filled in the discharge chambers is increased, and this tendency is liable to take place when the discharge chambers have the form close nearly to a box form.

Under the circumstances, it is a first object of the present invention to provide an excimer lamp that is enhanced in the radiation output of excimer rays.

It is a second object of the present invention to provide an excimer lamp that is enhanced in the radiation intensity of excimer rays without causing the cracking or breaking of discharge chambers.

The present inventors have made diligent studies and found that the above object can be achieved by a constitution in which electrodes for excimer discharge in an excimer lamp are plate electrodes, a plurality of discharge spaces and plate electrodes are alternately provided like one discharge space between two plate electrodes and optical radiation window(s) is/are provided in parallel with discharge channels of the discharge spaces. Further, it has been found that the above second object can be achieved by an excimer lamp having a constitution in which a luminous unit has a discharge chamber, a lamp chamber for housing said luminous unit is provided outside the luminous unit, a discharge gas is filled in the discharge chamber of said luminous unit, an inert gas is filled between the outer wall of the discharge chamber of the luminous unit and the inner wall of the lamp chamber, both the discharge gas and the inert gas are adjusted to have a pressure of 1 atmospheric pressure or more each and these two pressures are adjusted to ensure that the absolute value of a difference between the two pressures is 0.3 atmospheric pressure or lower. On the basis of finding of these, the present invention has been accordingly completed.

That is, the present invention provides

(1) An excimer lamp having at least an optical radiation window provided on the exit side of radiation of rays and a plurality of excimer discharge electrodes opposed to one another and having a constitution in which excimer discharge gas present in discharge space formed between the said opposed electrodes causes a discharge to radiate excimer rays,

said excimer discharge electrodes being flat-plate electrodes,

a plurality of said discharge spaces being provided, each of which is between flat-plate electrodes,

said optical radiation window being provided in parallel with discharge channels of said discharge spaces (to be referred to as “first excimer lamp” hereinafter),

(2) The excimer lamp as recited in the above (1), wherein said flat-plate electrodes are opposed to one another through a dielectric or dielectrics,

(3) The excimer lamp as recited in the above (2), wherein said flat-plate electrodes are surface-covered with the dielectric material,

(4) The excimer lamp as recited in the above (2), wherein said flat-plate electrodes are adjacent to main surfaces of plates formed of a dielectric material and the other main surfaces of said plates are adjacent to said discharge spaces,

(5) The excimer lamp in any one of the above (1) to (4), wherein said excimer discharge electrodes have an function of ultraviolet ray reflection,

(6) The excimer lamp as recited in any one of the above

(2) to (4), wherein a reflective mirror formed on the main surface of said dielectric or dielectrics has a function of ultraviolet ray reflection,

(7) An excimer lamp comprising

a luminous unit having a discharge chamber for radiating excimer rays and

a lamp chamber housing said luminous unit inside and having an optical output window provided on the exit side of radiation of rays,

wherein a discharge gas is filled in the discharge chamber of said luminous unit, an inert gas is filled between an outer wall of the discharge chamber of said luminous unit and an inner wall of said lamp chamber,

Both of said discharge gas and said inert gas have a pressure of 1 atmospheric pressure or more each and are adjusted to ensure that the absolute value of a difference between these two pressures is 0.3 atmospheric pressure or less (to be sometimes referred to as “second excimer lamp” hereinafter),

(8) The excimer lamp as recited in the above (7), wherein said luminous unit has a discharge chamber constituted of a plurality of discharge cells arranged in parallel,

a plurality of flat-plate electrodes for excimer discharge, which are opposed to one another while being in contact with main surfaces of the discharge cells,

said discharge chamber has an optical radiation window provided in parallel with discharge channel of the discharge chamber, and

the discharge gas filled in the discharge chamber causes a discharge to radiate excimer rays,

(9) The excimer lamp as recited in the above (7), wherein said discharge chamber further has discharge gas flow passage holes that go through said plurality of discharge spaces,

(10) The excimer lamp as recited in any one of the above (7) to (9), wherein said luminous unit has a discharge gas flow passage for introducing discharge gas into the discharge space from the outside of the lamp chamber, and

said lamp chamber has an inert gas flow passage for introducing inert gas into the lamp chamber from the outside of the lamp chamber.

According to the present invention, there can be provided an excimer lamp of which the excimer-ray radiation output power is enhanced, and according to the present invention, there can be provided an excimer lamp of which the excimer-ray radiation intensity is enhanced while causing none of the cracking and breakage of the discharge chamber.

### BRIEF DESCRIPTION OF DRAWINGS

FIG. 1 is a schematic cross-sectional view of an excimer lamp for explaining Embodiment 1 of the first excimer lamp of the present invention.

FIG. 2 is a schematic cross-sectional view of an excimer lamp for explaining Embodiment 2 of the first excimer lamp of the present invention.

FIG. 3 is a diagram showing one example of a flat-plate electrode for use in the excimer lamp of the present invention.

FIG. 4 is a diagram showing a luminous unit of Embodiment 1 of the first excimer lamp of the present invention.

FIG. 5 is a diagram showing a method of reflecting excimer rays generated in a discharge space in the excimer lamp of the present invention.

FIG. 6 is a schematic cross-sectional view of an excimer lamp for explaining the constitution of the second excimer lamp of the present invention.

FIG. 7 is a schematic cross-sectional view for explaining a method of adjusting the pressures of discharge gas and inert gas in the second excimer lamp of the present invention.

FIG. 8 is a schematic cross-sectional view for explaining the pressures of discharge gas and inert gas in the second excimer lamp of the present invention.

FIG. 9 is a schematic cross-sectional view of an excimer lamp for explaining the constitution of the second excimer lamp of the present invention.

FIG. 10 is a schematic cross-sectional view of an excimer lamp for explaining the constitution of the second excimer lamp of the present invention.

FIG. 11 is a schematic cross-sectional view of an excimer lamp for explaining the constitution of the second excimer lamp of the present invention.

FIG. 12 is a graph showing the relationship between the pressure of discharge gas (and the pressure of inert gas) and the amount of radiated rays in the excimer lamp of the present invention.

### BEST MODE OF THE INVENTION

In the present specification, an “excimer lamp” as used herein refers to a functionally high-power discharge lamp that radiates excimer rays. Regarding the term, it is not necessarily called in a unified term, and it is sometimes called “high-power beam generator” from the viewpoint of radiation of high-power excimer rays, “dielectric barrier discharge lamp” from the viewpoint of “dielectric barrier”, or “electrodeless field discharge excimer lamp” from the viewpoint of the state of being electrodeless in which no electrode is provided inside a discharge chamber and the radiation of excimer rays by application of high-frequency voltage to an internal electrode and an external electrode provided in the discharge chamber. The present specification gives them a generic name of “excimer lamp”.

First, the first excimer lamp of the present invention will be explained below.

The first excimer lamp is an excimer lamp having at least an optical radiation window provided on the exit side of radiation of rays and a plurality of excimer discharge electrodes opposed to one another and having a constitution in which excimer discharge gas present in discharge spaces formed between the said opposed electrodes causes a discharge to radiate excimer rays. This excimer lamp has a characteristic feature in that the above excimer discharge electrodes are flat-plate electrodes, a plurality of said discharge spaces are provided each of which is between flat-plate electrodes, and that the above optical radiation window is provided in parallel with discharge channels of said discharge spaces.

The first excimer lamp of the present invention will be explained with reference to drawings hereinafter.

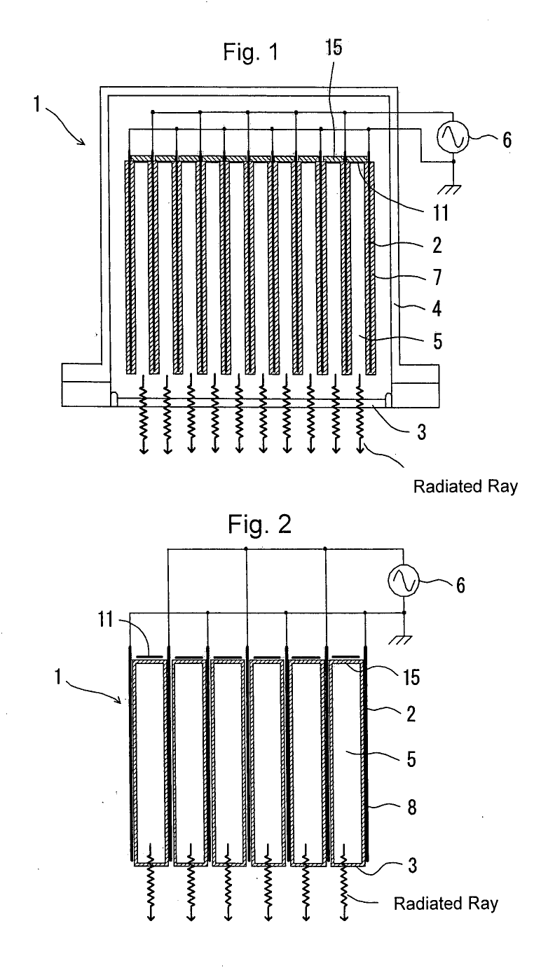

In the present invention, the first excimer lamp typically includes embodiments shown in FIGS. 1 and 2 (to be referred to as Embodiment 1 and Embodiment 2 hereinafter).

FIG. 1 is a schematic cross-sectional view of an excimer lamp for explaining Embodiment 1 of the first excimer lamp of the present invention. In FIG. 1, the excimer lamp 1 includes a chamber 4 having an optical radiation window 3 provided on the exit side of radiation of rays and a plurality of excimer discharge electrodes 2 opposed to one another. Discharge spaces 5 are formed alternately with the above plurality of opposed electrodes like one discharge space between two electrodes 2 and 2, and when a voltage is applied from a high-frequency power source 6, the excimer discharge gas present in the discharge spaces 5 causes a discharge to radiate excimer rays.

The optical radiation window 3 is not specially limited in form. An optical radiation window of which the main surface has the form of a circle, square, etc., may be used, while an optical radiation window of which the main surface has the form of a circle is preferred since such is easily available. The material for the optical radiation window 3 is not specially limited so long as it transmits excimer rays radiated by the discharge. When a cost and strength are taken into consideration, synthetic quartz glass, a magnesium fluoride crystal, a calcium fluoride crystal, etc., are preferred. The size of the optical radiation window 3 is determined as required depending upon the number of the discharge electrodes 2, and the like. When the optical radiation window 3 has the form of a circle, the optical radiation window 3 preferably has a diameter of approximately 5 to 40 cm and preferably has a thickness of approximately 5 to 20 mm.

The chamber 4 has a form that ensures an air-tight structure for filling a discharge gas in it and can have various forms of a cylinder, a cube, a rectangular parallelepiped and the like. Since the optical radiation window 3 preferably has the form of a circle in view of easy availability, the chamber 4 also preferably has the form of a cylinder. When the chamber 4 has the form of a cylinder, preferably, it has a size represented by a diameter of approximately 10 to 50 cm and a height of approximately 10 to 30 cm. The material of the chamber 4 is preferably a material that easily radiates heat and that does not easily generate impurity gas, and for example, it includes stainless steel, aluminum, and the like.

In a connection portion between the optical radiation window 3 and the chamber 4, preferably, a gasket, an O-ring, etc., are provided for securing air-tightness.

FIG. 2 is a schematic cross-sectional view of an excimer lamp for explaining Embodiment 2 of the first excimer lamp of the present invention. The excimer lamp 1 in FIG. 2 also has optical radiation windows 3 provided on the exit side of radiation of rays and a plurality of excimer discharge electrodes 2 opposed to one another. Discharge spaces 5 are formed between the above plurality of opposed electrodes 2 and 2, and when a voltage is applied from a high-frequency power source 6, an excimer discharge gas present in the above discharge spaces 5 causes a discharge to radiate excimer rays.

In Embodiment 2 shown in FIG. 2, each discharge space 5 is surrounded by the optical radiation window 3, a plate 8 formed of a dielectric material, a top plate 15, etc., so as to form a box, and the discharge gas is air-tightly filled in each discharge space 5. In the Embodiment shown in FIG. 2, therefore, the chamber 4 shown in Embodiment shown in FIG. 1 is not necessarily required. Further, as the optical radiation windows 3, a window similar to the above optical radiation window may be used except that the form thereof is limited to the form of a rectangle.

Embodiments of the first excimer lamp of the present invention will be explained mainly on the basis of Embodiment 1, while they will be explained in contrast with Embodiment 2 as required.

In FIG. 1 (or FIG. 2), an excimer discharge gas is present in the discharge space 5 of the excimer lamp. The excimer discharge gas includes rare gases such as xenon gas, argon gas, krypton gas, etc., mercury gas and a gas mixture of the above rare gas or mercury gas with halogen gas such as fluorine gas, chlorine gas, bromine gas or iodine gas.

The central wavelength of excimer rays obtained is determined depending upon a discharge gas. When xenon gas is used, it is 172 nm, when argon gas is used, it is 126 nm, when krypton gas is used, it is 146 nm, when a gas mixture of argon gas with chlorine is used, it is 175 nm, when a gas mixture of xenon gas with chlorine gas is used, it is 308 nm, when a gas mixture of krypton gas with chlorine gas is used, it is 222 nm, when a gas mixture of mercury gas with iodine gas is used, it is 443 nm, when a gas mixture of mercury gas with bromine gas is used, it is 503 nm, and when a gas mixture of mercury gas with chlorine gas is used, it is 558 nm.

The gas pressure of the excimer discharge gas in the chamber is preferably 0.5 to 3 atmospheric pressures, more preferably approximately 1 atmospheric pressure.

The most characteristic points of the first excimer lamp of the present invention are that the excimer discharge electrodes 2 are flat-plate electrodes, that a plurality of discharge spaces 5 are provided between the two flat-plate electrodes and that the optical radiation window 3 is provided in parallel with discharge channels of the discharge spaces. When the electrodes are shaped in the form of a flat plate each, broad discharge spaces 5 can be formed between the excimer discharge electrodes 2 and 2 that extend from that side (upper side in FIG. 1 (or FIG. 2)) which is opposite to the exit side of radiation of rays to the exit side of radiation (lower side in FIG. 1 (or FIG. 2)), and high-power excimer rays can be outputted through the optical radiation window 3 while integrating excimer rays generated at any places between any excimer discharge electrodes 2 and 2.

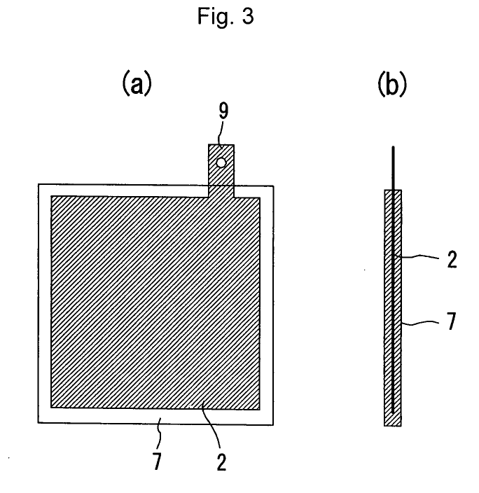

FIG. 3 shows one example of the flat-plate electrode for use in the excimer lamp in Embodiment 1. FIG. 3(a) is a perpendicular cross-sectional view of the flat-plate electrode 2 viewed in the direction of its main surface, and FIG. 3(b) is a perpendicular cross-sectional view of the plate electrode 2 viewed in the direction of its side surface. In FIG. 1 and FIG. 3, the electrode 2 shown in FIG. 1 and the flat-plate electrode 2 shown in FIG. 3(b) correspond to each other in form.

Each flat-plate electrode 2 preferably has a length of 2 to 50 cm, a width of 2 to 50 cm and a thickness of approximately 0.2 to 5.0 mm.

The material for the plate electrodes 2 is not specially limited so long as it is capable of generating excimer rays between the electrodes. When the function of ultraviolet ray reflection to be described later is taken into account, it is preferably aluminum or a material obtained by forming an aluminum film or a dielectric multi-layer film on a metal surface. The metal on the surface of which the aluminum film or dielectric multi-layer film is formed is preferably copper, silver, gold, or the like in view of electric conductivity and thermal conductivity. Further, the dielectric multi-layer film is preferably a film formed by alternately stacking magnesium fluoride layers and lithium fluoride layers.

In Embodiment 2, flat-plate electrodes similar to those described above can be used.

In the first excimer lamp of the present invention, flat-plate electrodes having different polarities are alternately arranged to be opposed to one another via dielectric materials. As an embodiment in which the plate electrodes 2 are alternately arranged to be opposed to one another via dielectric materials, there is an embodiment in which plate electrodes 2 the surface of each of which is covered with a dielectric material 7 as shown in FIG. 3 are opposed to one another as shown in FIG. 1. In Embodiment 2, there can be employed an embodiment as shown in FIG. 2, in which a plate electrode 2 is adjacent to one main surface of a plate 8 formed of a dielectric material, the other main surface of this plate 8 is adjacent to a discharge space 5 and in this manner such plate electrodes are alternately arranged to be opposed to one another. In FIG. 1, further, the constitution in which the flat-plate electrodes the surface of each of which is covered with the dielectric material 7 are opposed to one another may be replaced with a constitution in which such a plate electrode 2 is adjacent to one main surface of a plate 8 formed of a dielectric material, the other main surface of this plate 8 is adjacent to a discharge space 5 and such plate electrodes are alternately arranged to be opposed to one another. When the plate electrodes are arranged as shown in FIG. 1 or 2, the plate electrodes other than the plate electrodes provided on the leftmost end and rightmost end in Figure can be used to apply a voltage to adjacent two discharge spaces 5 and 5, so that the total number of the plate electrodes 2 in the excimer lamp can be decreased, which can decrease a cost.

The dielectric material can be selected from known materials such as synthetic quartz glass, calcium fluoride, magnesium fluoride, and the like.

The flat-plate electrode 2 that is surface-covered with the dielectric material 7 as shown in FIG. 3 can be produced, for example, by a method in which two plate-shaped materials formed of a synthetic quartz glass each are provided, each having one surface on which aluminum is deposited, a plate electrode is sandwiched between the two plate-shaped materials with the deposition surfaces inside and they are bonded with an inorganic adhesive.

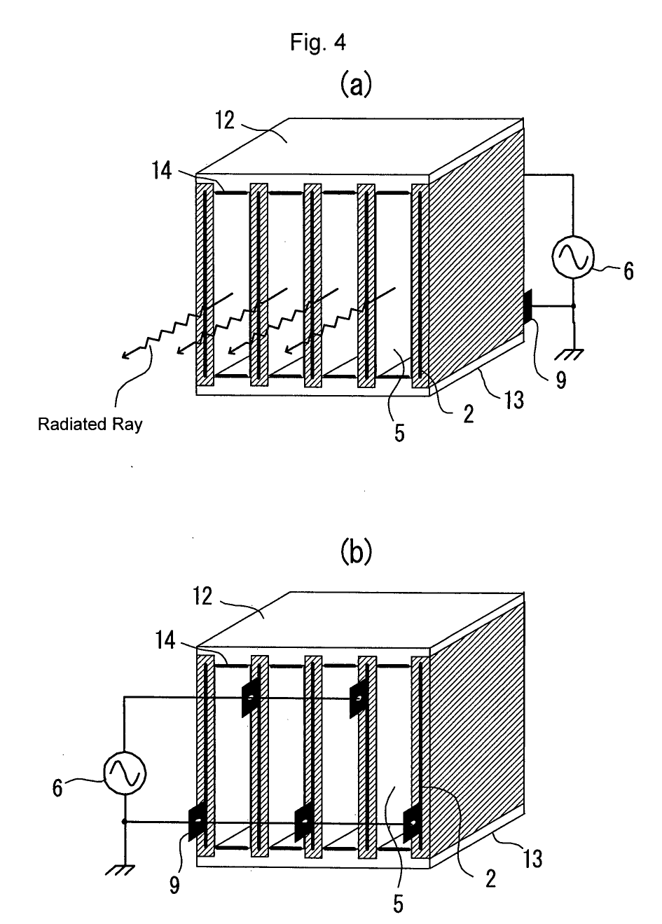

FIG. 4 shows a luminous unit comprising a plurality of the flat-plate electrodes 2 and discharge spaces 5 formed alternately with them like one discharge space between two plate electrodes, in which FIG. 4(a) shows the luminous unit viewed from the exit side of radiation of rays and FIG. 4(b) shows the luminous unit viewed from the side opposite to the exit side of radiation of rays.

In Embodiment 1, side plates 12 and 13 may be provided to form a box-shaped luminous unit together with the plate electrodes 2 as shown in FIGS. 4(a) and 4(b). The above side plates 12 and 13 are preferably made from ceramic, synthetic quartz glass, or the like.

Further, a plate (top plate) may be provided on that surface (front-side surface of the luminous unit shown in FIG. 4(b)) which is opposite to the exit side of radiation, and this top plate is also preferably made from ceramic, synthetic quartz glass, or the like.

In Embodiment 2, as is partially shown in FIG. 2, each discharge space 5 is surrounded by a top plate 15 and side plates together with the optical radiation window 3 and the plate 8 formed of a dielectric material and each discharge space is air-tightly filled with a discharge gas.

As shown in FIGS. 3 and 4(b), each flat-plate electrode 2 has a contact 9 to constitute a structure in which the contact 9 is electrically connectable to the high-frequency power source 6 as shown in FIG. 4(b). When the above constitution is employed, the discharge spaces 5 can be caused to generate excimer rays by applying a voltage from the high-frequency power source.

Further, in Embodiment 1, preferably, the plate electrodes 2 shown in FIGS. 1 and 3 have the function of ultraviolet ray reflection, or a reflective mirror having the function of ultraviolet ray reflection is formed on the main surface of each dielectric material 7 as will be discussed later.

In FIG. 1, excimer rays are generated at any place between two electrodes 2 extending vertically in Figure, and for outputting excimer rays generated on the upper side in Figure (the side opposite to the exit side of radiation of excimer rays) from the lower side (the exit side of radiation of excimer rays), it is required to reflect excimer rays generated on the upper side in Figure toward the lower side in Figure.

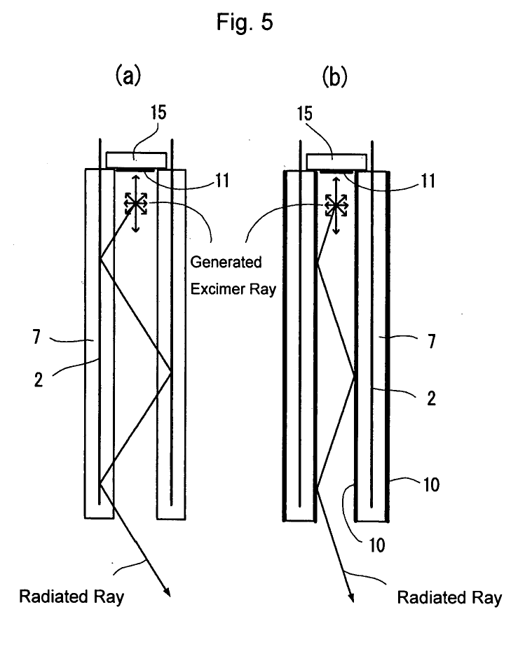

Therefor, preferably, the plate electrodes 2 are formed from a material having the function of ultraviolet ray reflection as shown in FIG. 5(a) or a reflective mirror 10 having the function of ultraviolet ray reflection is formed on each dielectric material 7 as shown in FIG. 5(b), to output excimer rays generated on the upper side in Figure toward the lower side in Figure.

In the first excimer lamp of the present invention, the function of ultraviolet ray reflection means the function to be capable of reflecting at least ultraviolet rays, and the material having the function of ultraviolet ray reflection may be a material that reflects visible light and infrared rays together with ultraviolet rays.

The material for the reflective mirror 10 includes a dielectric multi-layer film, and the like. The dielectric multi-layer film is preferably a film formed by alternately stacking magnesium fluoride films and lithium fluoride films.

As shown in FIGS. 4(a) and 4(b), further, when a box-shaped luminous unit is formed by providing the side plates 12 and 13 together with the plate electrodes 2, preferably, a reflective mirror 14 is formed on each of the side plates 12 and 13.

The reflective mirror 14 may be formed on the internal surface (surface on the discharge space 5 side) as shown in FIGS. 4(a) and 4(b). When the side plate 12 or 13 is formed of a material capable of transmitting excimer rays, the reflective mirror 14 may be formed on the outer surface of each of the side plates 12 and 13 (top surface and bottom surface of the luminous unit shown in FIGS. 4(a) and 4(b)). As a material for the reflective mirror 14, the same material as that for the above reflective mirror 10 can be employed.

As shown in FIGS. 1 and 5, preferably, a reflective mirror 11 is as well formed on the surface that is opposite to the exit side of radiation of excimer rays. Owing to the reflective mirror 11, excimer rays going toward the surface opposite to the exit side of radiation of excimer rays can be reflected toward the exit side of radiation of excimer rays.

As shown in FIGS. 1 and 5, the reflective mirror 11 may be formed on the internal surface of the top plate 15 (surface on the discharge space 5). When the top plate is formed of a material capable of transmitting excimer rays, it may be formed on the outer surface of the top plate (surface opposite to the discharge space 5). As a material for the reflective mirror 11, the same material as that for the above reflective mirror 10 can be employed.

In Embodiment 2, preferably, the flat-plate electrodes 2 shown in FIG. 2 also have the function of ultraviolet ray reflection. Further, preferably, a reflective mirror having the function of ultraviolet ray reflection is formed on the main surface of the plate 8 formed of a dielectric material, and also preferably, a reflective mirror is formed on each of the top plate 15 and side plates surrounding the discharge space 5. When the reflective mirror is formed on each of the plate 8, the top plate 15 and the side plates, it may be formed on that surface of each of the plate 8, the top plate 15 and the side plates which is in contact with the discharge space 5. When each of the plate 8, the top plate 15 and the side plates is formed of a material capable of transmitting excimer rays, the reflective mirror may be formed on that surface of each of the top plate 15, the side plates and the plate 8 which is opposite to the surface in contact with the discharge space 5, like a reflective mirror 11 shown in FIG. 2.

The material for the reflective mirror can be selected from the above dielectric multi-layer film or an aluminum film.

As shown in FIG. 1 (or FIG. 2), the first excimer lamp of the present invention has the discharge space 5 formed between the flat-plate electrodes 2 and 2, and it has a plurality of such discharge spaces.

When the discharge space 5 is formed while the plate electrodes 2 are opposed to one another as described above, a broader discharge space can be formed and high-power excimer rays can be outputted through the optical radiation window 3 while integrating excimer rays generated at any places between any two excimer discharge electrodes 2 and 2. Further, when a plurality of such discharge spaces 5 are provided, the excimer lamp can be increased in area.

The width (discharge channel length) of each discharge space is preferably over 0 mm but not more than 10 mm, more preferably 1 to 5 mm.

The number of the discharge spaces 5 that are arranged between the plate electrodes 2 and 2 can be determined as required by taking account of the area of an object to be treated.

In the excimer lamp of the present invention, the optical radiation window 3 is provided in parallel with the discharge channels of the discharge spaces 5 as shown in FIG. 1 (or FIG. 2). When the above structure is employed, high-power excimer rays can be outputted through the optical radiation window 3 while integrating excimer rays generated at any places between the upper side of Figure (the side opposite to the exit side of radiation of excimer rays) to the lower side of Figure (the exit side of radiation of excimer rays).

The voltage to be applied from the high-frequency power source 6 shown in FIG. 1 (or FIG. 2) is determined as required depending upon discharge conditions. Generally, there is used a voltage region of approximately 0.5 kVp-p to 20 kVp-p in a high frequency region of approximately 10 kHz to 20 MHz, several GHz and a microwave region.

The second excimer lamp of the present invention will be explained below.

The second excimer lamp of the present invention is an excimer lamp comprising a luminous unit having a discharge chamber for radiating excimer rays and a lamp chamber housing said luminous unit inside and having an optical output window provided on the exit side of radiation of rays,

wherein a discharge gas is filled in the discharge chamber of said luminous unit, an inert gas is filled between an outer wall of the discharge chamber of said luminous unit and an inner wall of said lamp chamber, both said discharge gas and said inert gas have a pressure of 1 atmospheric pressure or more each and are adjusted to ensure that the absolute value of a difference between these two pressures is 0.3 atmospheric pressure or less.

The embodiment of the second excimer lamp of the present invention will be explained below with reference to drawings.

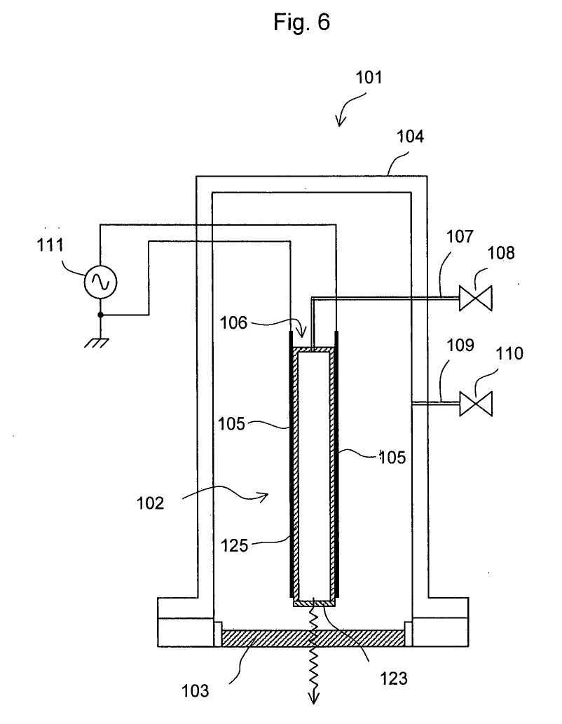

FIG. 6 is a schematic cross-sectional view of an excimer lamp for explaining the constitution of the second excimer lamp of the present invention. In FIG. 6, an excimer lamp 101 comprises a luminous unit 102 having a discharge chamber 106 for radiating excimer rays and a lamp chamber 104 housing the luminous unit 102 inside and having an optical output window 103 on the exit side of radiation of rays.

The discharge chamber 106 constituting the luminous unit 102 shown in FIG. 6 is formed of a discharge cell 125 having the form of a nearly rectangular parallelepiped, and in the box-shaped discharge chamber 106, a discharge space extends from this side to the opposite side in Figure so as to form a box-like form. In the excimer lamp of the present invention, the form of the discharge chamber constituting the luminous unit is not specially limited so long as it has an air-tight structure in which a discharge gas can be filled inside it. Besides the above form of a parallelepiped, various forms such as a regular hexahedron, a cylinder, a dual cylinder, etc., can be employed. For obtaining high-power excimer rays, a plurality of discharge spaces may be formed inside the discharge chamber. As the above discharge chamber, it is preferred to use a discharge chamber in which a plurality of discharge cells and flat-plate electrodes are alternately arranged in parallel and a plurality of discharge spaces are provided in parallel inside as will be described later.

The discharge chamber 106 forming the above discharge space is formed of a dielectric material, and the dielectric material can be selected from known materials such as synthetic quartz glass, calcium fluoride, magnesium fluoride, and the like.

The optical output window 103 shown in FIG. 6 has the main surface having the form of a circle, while the form of the optical output window is not specially limited. Besides the optical output window of which the main surface has the form of a circle, various optical output windows such as one of which the main surface has the form of a square, etc., can be used. In view of easiness of availability, an optical output window of which the main surface has the form of a circle is preferred. The material for the optical output window is not specially limited, either, while synthetic quartz glass, a magnesium fluoride crystal, a calcium fluoride crystal, etc., are preferred when a cost and strength are taken into consideration. Concerning the size of the optical output window, further, when it has the form of a circle, its diameter is preferably approximately 2 to 60 cm and its thickness is preferably approximately 2 to 50 mm.

The lamp chamber 104 shown in FIG. 6 has the form of a cylinder, while the form of the lamp chamber is not specially limited so long as it has an air-tight structure in which an inert gas can be filled inside. Beside the above form of a cylinder, there can be employed various forms such as the form of a regular hexahedron, a rectangular parallelepiped, and the like. Since the optical window preferably has the form of a circle due to easiness of availability as described above, the lamp chamber preferably has the form of a cylinder as well. When the lamp chamber has the form of a cylinder, preferably, it has a size having a diameter of approximately 10 to 70 cm, a height of approximately 10 to 80 cm and a side wall thickness of approximately 1 to 10 mm. The material for the lamp chamber is not specially limited, while it is preferably a material that easily radiates heat and that does not easily generate any impurity gas, such as stainless steel, aluminum, or the like.

Preferably, a gasket, an C-ring, or the like is provided between the optical output window and the lamp chamber to secure air-tightness.

In FIG. 6, electrodes 105 and 105 constituting the luminous unit 102 are provided on the main surface of the discharge chamber 106, and are electrically connected to a high-frequency power source 111 provided outside the lamp chamber 104. In FIG. 6, the electrodes 105 have the form of a flat plate. However, the form of the electrodes is not specially limited, and they can have various forms depending upon the form of the discharge chamber.

When the electrodes 105 have the form of a flat plate, there can be employed those sizes and materials which are explained with regard to the plate electrodes of the first excimer lamp.

In FIG. 6, a discharge gas is filled in the discharge chamber 106 and an inert gas is filled between the outer wall of the discharge chamber 106 and the inner wall of the lamp chamber 104. When a voltage is applied between the electrodes 105 and 105 from the high-frequency power source 111, the discharge gas filled in the discharge chamber 106 causes a discharge to generate excimer rays.

The discharge gas includes rare gases such as xenon gas, argon gas, krypton gas, etc., and gas mixtures of the above rare gases with chlorine. The inert gas includes rare gases such as helium gas, neon gas, argon gas, krypton gas, xenon gas, etc., besides nitrogen gas. When the above rare gases are used as inert gases, they sometimes cause a discharge outside the discharge chamber since they have low ionization potentials for starting discharges. It is hence preferred to fully insulate a wiring to the electrodes in the lamp chamber beforehand.

The central wavelength of excimer rays to be obtained is determined depending upon discharge gases. For example, when xenon gas is used, it is 172 nm, when argon gas is used, it is 126 nm, when krypton gas is used, it is 146 nm, when a gas mixture of argon with chlorine is used, it is 175 nm, when a gas mixture of xenon with chlorine is used, it is 308 nm, and when a gas mixture of krypton with chlorine is used, it is 222 nm.

The most characteristic feature of the second excimer lamp of the present invention is that both the pressure of the above discharge gas and the pressure of the above inert gas are 1 atmospheric pressure or more and that these pressures are adjusted to ensure that the absolute value of difference between these two pressures is 0.3 atmospheric pressure or less. That is, as a result of diligent studies that the present inventors have made, it has been found that when the pressure of the discharge gas is set at 1 atmospheric pressure or more and the pressure of the inert gas present around the discharge chamber is adjusted to be almost equal to the pressure of the discharge gas, the radiation intensity of excimer rays can be increased without causing the cracking or breaking of the discharge chamber, and the present invention has been accordingly completed on the basis of the above finding.

With an increase in the pressure of the discharge gas, the radiation intensity of excimer rays increases. Therefore, the pressures of the discharge gas and the inert gas are preferably 1.5 atmospheric pressures or more, more preferably 2 atmospheric pressures or more. However, when the pressures of the discharge gas and the inert gas are too high, it is required to increase the thickness of each of the discharge chamber and the lamp chamber, so that the pressures of the discharge gas and the inert gas are preferably 10 atmospheric pressures or less. Further, the absolute value of a difference between the pressure of the discharge gas and the pressure of the inert gas is preferably adjusted to 0.1 atmospheric pressure or less, more preferably to 0.05 atmospheric pressure.

The voltage to be applied from the high-frequency power source 111 is determined as required depending upon discharge conditions. Generally, there is used a voltage region of approximately 0.5 kVp-p to 20 kVp-p in a high frequency region of approximately 10 kHz to 20 MHz, several GHz and a microwave region.

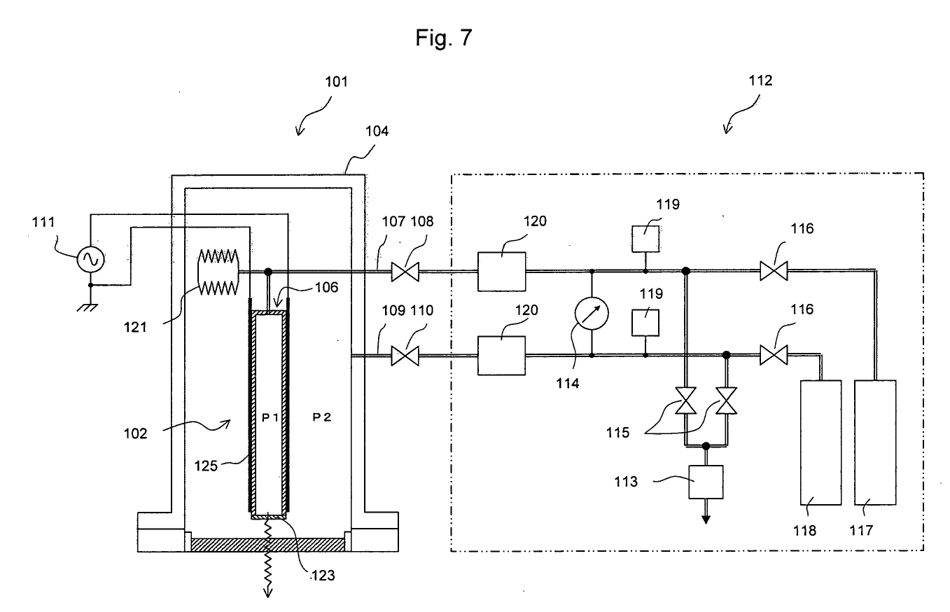

The method for adjusting the pressure of the above discharge gas and the pressure of the above inert gas will be explained below with reference to FIG. 7.

In FIG. 7, a discharge gas flow passage 107 for introducing discharge gas to a discharge space of a discharge chamber 106 from the outside of a lamp chamber 104 is connected to a gas valve 108 that is a sealing means for sealing a discharge gas in a discharge chamber 106. Further, an inert gas flow passage 109 for introducing inert gas into the lamp chamber from the outside of the lamp chamber 104 is connected to a gas valve 110 that is a sealing means for sealing an inert gas in the lamp chamber.

In FIG. 7, a gas supply/exhaust apparatus 112 that enables the supply and exhaust of discharge gas and inert gas through the gas valve 108 and the gas valve 110 is connected to the excimer lamp 101.

When the discharge gas and the inert gas are supplied to the discharge chamber 106 and the lamp chamber 104, the discharge chamber 106 and the lamp chamber 104 are first subjected to evacuation. This evacuation is carried out by vacuuming with a vacuum pump 113 while the above gas valve 108 and gas valve 110 are in an open state. In this case, for preventing the blowout of the discharge chamber 102, preferably, pressure control valves 115 and 115 for exhaust are turned on and off while the pressure difference between a gas pressure P1 in the discharge chamber and a gas pressure P2 in the lamp chamber is checked with a differential pressure gauge 114, to ensure that the above pressure difference is as small as possible.

After the evacuation, the pressure control valves 115 and 115 for exhaust are closed, and pressure control valves 116 and 116 for supply are opened, to supply the discharge gas and the inert gas from a discharge gas cylinder 117 and an inert gas cylinder 118. In this case, the pressure control valves 116 and 116 for supply are turned on and off while pressure gauges 119 and 119 and the differential pressure gauge 114 are checked, to ensure that the pressure of each of the discharge gas and inert gas is a predetermined pressure of 1 atmospheric pressure or more and that the absolute value of a difference between these two pressures is 0.3 atmospheric pressure or less.

The above gas supply/exhaust apparatus 112 preferably has tanks 120 and 120 as a buffer.

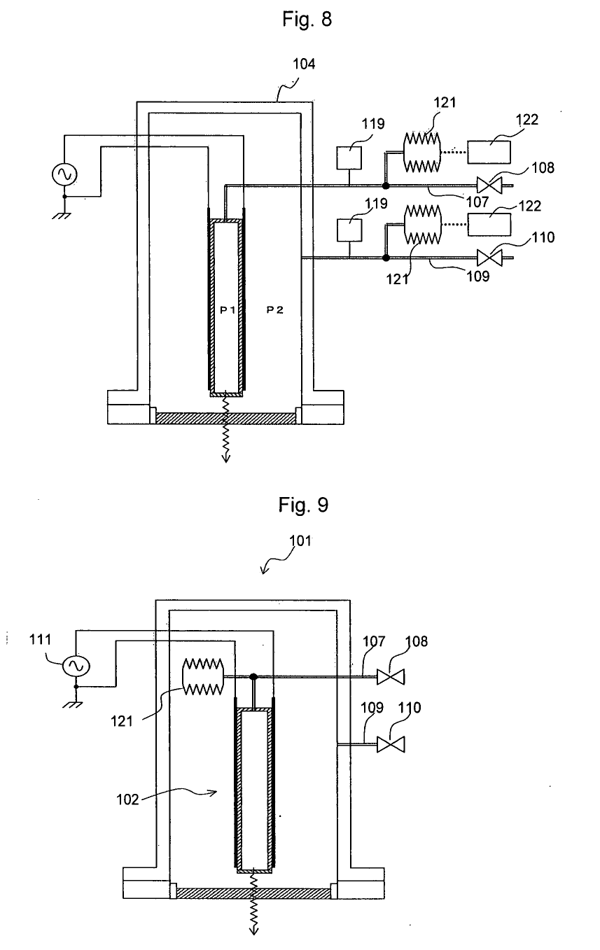

As means for adjusting the difference between the pressure of discharge gas and the pressure of inert gas, further, a volume adjusting means 121 may be provided as shown in FIG. 7. In FIG. 7, the volume adjusting means 121 is provided to a terminal of a gas flow passage branching from the discharge gas flow passage 107 in the lamp chamber 104. When a pressure difference occurs between the gas pressure P1 in the discharge chamber and the gas pressure P2 in the lamp chamber, the above volume adjusting means 121 swells or shrinks thereby to decrease the difference between the pressure of discharge gas and the pressure of inert gas. Further, the volume adjusting means 121 may be provided outside the lamp chamber 104 as shown in FIG. 8. In this case, a volume adjusting means 121 having an actuator 122 is provided to the terminal of a gas flow passage branching from the discharge gas flow passage 107 and a volume adjusting means 121 having an actuator 122 is provided to the terminal of a gas flow passage branching from the inert gas flow passage 109. Pressure gauges 119 are provided in the discharge gas flow passage 107 and the inert gas flow passage 109, and the volume adjusting means 121 are swollen and shrunken thereby to decrease pressure differences indicated by the two pressure gauges. These volume adjusting means 121 include bellows, a piston, a diaphragm, and the like.

After the pressure of the discharge gas and the pressure of the inert gas are adjusted to predetermined values, the gas valve 108 and the gas valve 110 are closed, whereby these gases can be hermetically filled in the excimer lamp 101, and the excimer lamp 101 is then separated from the gas supply apparatus 112 and can be used in various purposes in a state shown in FIG. 6 or FIG. 9. The gas valve 108 and the gas valve 110 of the excimer lamp 101 may be removed after the discharge gas flow passage 107 and the inert gas flow passage 109 are sealed off, while it is preferred not to remove them in order to provide for a case when discharge gas and inert gas are introduced again. When the volume adjusting means 121 are used when discharge gas and inert gas are introduced and their passages are sealed, preferably, the excimer lamp 101 has the volume adjusting means 121 after the passages of these gases are sealed. That is because when the pressures of the discharge gas and the inert gas vary after the passages of these gases are sealed, the pressure difference can be easily adjusted with the volume adjusting means 121. Therefore, the volume adjusting means may be provided in advance for adjusting the pressure difference after the passages of the discharge gas and the inert gas are sealed.

A preferred embodiment of the luminous unit will be explained below.

The second excimer lamp of the present invention preferably has a constitution in which the above luminous unit has a discharge chamber constituted of a plurality of discharge cells arranged in parallel,

a plurality of flat-plate electrodes for excimer discharge, which are opposed to one another while being in contact with main surfaces of the discharge cells,

said discharge chambers have optical radiation windows provided in parallel with discharge channels of the discharge chambers and

the discharge gas filled in said discharge chambers cause discharge to radiate excimer rays.

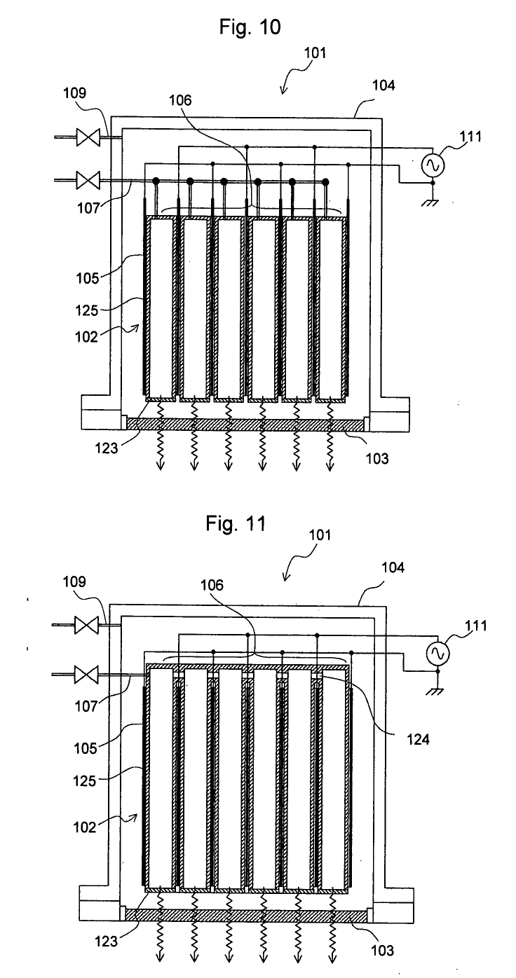

FIG. 10 shows one embodiment of the above excimer lamp.

A luminous unit 102 has a discharge chamber 106 constituted of a plurality of discharge cells 125 arranged in parallel and a plurality of excimer discharge flat-plate electrodes 105 arranged one to another while being in contact with main surfaces of a plurality of the discharge cells 125.

In the above manner, a box-shaped discharge cell 125 having a hollow portion inside is arranged between electrodes 105 and 105 opposed to each other, and a plurality of electrodes 105 opposed to one another and a plurality of discharge cells 125 are alternately arranged. In the discharge chamber 106, a plurality of nearly box-shaped discharge spaces are formed. A discharge channel (extending from left to right in FIG. 10) is formed between electrodes 105 and 105, and an optical radiation window 123 is provided in parallel with the discharge channel. When a voltage is applied through the electrodes 105 from a high-frequency power source 111, discharge gas filled in the above discharge space causes a discharge to radiate excimer rays.

In the above embodiment, the electrodes are formed in the form of a flat plate each, whereby a broad discharge space can be formed between the electrodes 105 and 105 extending from a side (upper side in FIG. 10) opposite to the optical radiation window 123 to the optical radiation window 123 (lower side in FIG. 10), so that high-power excimer rays can be outputted from the optical radiation window 123 while integrating excimer rays generated at any places between the electrodes 105 and 105. In this case, preferably, the plate electrodes are formed from a material having the function of ultraviolet ray reflection and a reflective mirror having the function of ultraviolet ray reflection is formed on the inner wall or outer wall surface of the discharge cell 106, to lead excimer rays generated on the upper side in Figure toward the lower side in Figure.

The function of ultraviolet ray reflection as used with regard to the second excimer lamp of the present invention means the capability of reflecting ultraviolet ray, and the material having the function of ultraviolet ray reflection may be a material that reflects visible light and infrared together with ultraviolet rays.

The material for the above reflective mirror includes aluminum and a dielectric multi-layer film. As a dielectric multi-layer film, a film obtained by alternately stacking magnesium fluoride layers and lithium fluoride layers is, preferred.

In the embodiment shown in FIG. 10, the plate electrodes excluding those plate electrodes provided in right and left ends in Figure can apply a voltage to two adjacent discharge spaces, so that the total number of the plate electrodes 105 in the excimer lamp can be decreased, which can lead to the reduction of a cost.

The width of the discharge space (discharge channel length) is preferably 1 to 30 mm, more preferably 3 to 10 mm. The number of discharge spaces formed alternately with the plate electrodes like one discharge space between two plate electrodes 105 and 105 can be determined as required by taking account of the area of an object to be treated.

As shown in FIG. 10, when flow passages branching from a discharge gas flow passage 107 to the discharge spaces, discharge gas can be filled in the discharge spaces of the discharge chamber 106. On the other hand, when discharge chamber 106 has a discharge gas flow passage holes 124 that go through a plurality of the discharge spaces, discharge gas can be filled in the discharge chamber without branching the discharge gas flow passage 107 to the individual discharge spaces.

### EXAMPLES

The present invention will be explained further in detail with reference to Examples hereinafter, while the present invention shall not be limited by these Examples.

### Example 1

### Production Example of First Excimer Lamp

Fifteen flat-plate electrodes 2 made of aluminum having a form shown in FIG. 3 each were prepared, each of which was surface-polished and had a length of 10 cm, a width of 10 cm and a thickness of 0.5 mm, and they were entirely surface-coated with synthetic quartz glass as a dielectric material except their contacts 9.

A top plate 15 as shown in FIG. 5(a) was formed with a ceramic plate, and the above flat-plate electrodes 2 made of aluminum and surface-coated entirely with synthetic quartz glass were arranged so as to be opposed to one another in a plate to plate distance of 5 mm. Further, side plates 12 and 13 that were at right angles with the main surfaces of the plate electrodes 2 as shown in FIGS. 4(a) and 4(b) were formed with ceramic plates, to produce a luminous unit having a plurality of box-shaped discharge spaces 5. Although FIGS. 4(a) and 4(b) show five plate electrodes 2, fifteen plate electrodes 2 were actually used.

A reflective mirror 11 as shown in FIG. 1 was formed on that surface of the top plate 15 which was on the side of the discharge spaces 5, and the reflective 11 was constituted of a dielectric multi-layer film. As shown in FIG. 1, the above luminous unit was set in a cylindrical chamber 4 (diameter 25 cm, height 15 cm) made of aluminum and the contacts 9 of the plate electrodes 2 were connected to a high-frequency power source 6. In the above luminous unit, the plate electrodes 2 were arranged to ensure that they were alternately had different polarities as shown in FIG. 1, and the flat-plate electrodes 2 on the left end and right end in Figure were earthed (grounded).

A circular window made of synthetic quartz having a diameter of 14 cm and a thickness of 10 mm was provided as an optical radiation window 3 and attached to the chamber 4 through a gasket to produce an excimer lamp as shown in FIG. 1. As an excimer discharge gas, a xenon gas having a pressure of 0.7 atmospheric pressure was filled in the chamber 4, and a high-frequency voltage having a frequency of 1.6 MHz and a voltage of 4 kVp-p was applied from the high-frequency power source 6 to generate excimer rays.

The above excimer rays had an output of 280 mW/cm², and the output that could be obtained was about 5 times the output of an excimer lamp having a nearly equivalent discharge space.

### Example 2

### Production Example of First Excimer Lamp

An excimer lamp was produced in the same manner as in Example 1 except that a dielectric multi-layer film formed by alternately stacking magnesium fluoride thin layers and lithium fluoride thin layers was formed on the main surfaces of the dielectric materials 7 as shown in FIG. 5(b), and excimer rays were generated in the same manner as in Example 1.

The above excimer rays had an output of 310 mW/cm², and like the result in Example 1, the output that could be obtained was about 5 times the output of an excimer lamp having a nearly equivalent discharge space.

### Example 3

### Production Example of Second Excimer Lamp

An excimer lamp 101 comprising a luminous unit 102 having a discharge chamber 106 having the form of a parallelepiped as shown in FIG. 6 was produced.

For producing a luminous unit 102, first, a box-shaped discharge cell 125 having a longitudinal length of 150 mm, a transverse length of 100 mm and a width of 7 mm was prepared and used as a discharge chamber 106. The discharge chamber 106 had a hollow having a longitudinal length of 148 mm, a transverse length of 98 mm and a width of 5 mm, and this hollow was to form a discharge space having a discharge channel length of 5 mm during a discharge. Flat-plate electrodes 105 having a length of 130 mm, a width of 80 mm and a thickness of 1 mm were arranged such that they were placed on both the main surfaces of the discharge chamber 106 one on each. As shown in FIG. 6, the discharge chamber 106 having the thus-arranged plate electrodes 105 was housed in a lamp chamber 104 (diameter 200 mm, a height 400 mm) made of stainless steel, and an end portion of a discharge gas flow passage 107 was connected to a hole made on the side (upper side in Figure) opposite to the radiation side of the discharge chamber 106, to give a luminous unit 102. Further, the two plate electrodes 105 were connected to a high-frequency power source 111 provided outside the lamp chamber 104.

The above lamp chamber 104 had an inert gas flow passage 109 for introducing inert gas into the lamp chamber 104, and it also had a circular window having a diameter of 100 mm and a thickness of 10 mm as an optical output window 103. The circular window was attached to the lamp chamber through a gasket.

For supplying the discharge chamber 106 and the lamp chamber 104 with discharge gas and inert gas, the above discharge gas flow passage 107 and the above inert gas flow passage 109 were connected to a gas supply/exhaust apparatus 112 through a gas valve 108 and a gas valve 110, respectively.

First, evacuation was carried out with a vacuum pump 113 in a state where the above gas valve 108 and gas valve 110 were opened, thereby to vacuum the discharge chamber 106 and the lamp chamber 104. For preventing the breakage of the discharge chamber 106, pressure control valves 115 for exhaust were turned on and off during the vacuuming so that the pressure difference between the gas pressure P1 in the discharge chamber 106 and the gas pressure P2 in the lamp chamber 104 was made as small as possible while the pressure difference was checked through a differential pressure gauge 114.

After the vacuuming, the pressure control valves 115 for exhaust were closed and then pressure control valves 116 for supply were opened to supply discharge gas (xenon gas) and inert gas (nitrogen gas) from a discharge gas cylinder 117 and an inert gas cylinder 118. In this case, the pressure control valves 116 for supply were turned on and off while checking pressure gauges 119 and the differential pressure gage 114, so that the xenon gas and the nitrogen gas had a pressure of 1 atmospheric pressure each and that the absolute value of a difference between these two pressures was 0.3 atmospheric pressure or less.

For the above vacuuming and gas supply, the gas supply/exhaust apparatus 112 is provided with tanks 120, and as means for adjusting a difference between the pressure of discharge gas and the pressure of inert gas, the lamp chamber 104 is internally provided with bellows 121 as a volume adjusting means as shown in FIG. 7.

After the pressure of the discharge gas and the pressure of the inert gas were adjusted to predetermined values, the gas valves 108 and 110 were closed to seal these gases and separated from the gas supply/exhaust apparatus 112, to give an excimer lamp 101 shown in FIG. 9. Both the pressure of xenon gas and the pressure of nitrogen gas in the excimer lamp 101 were 1 atmospheric pressure, and the difference between these two pressures was nearly zero.

A high-frequency voltage having a frequency of 1.9 MHz and a voltage of 3.5 kVp-p was applied to the excimer lamp 101 from the high-frequency power source 111 to generate excimer rays, and the discharge chamber 106 caused neither cracking nor breaking.

Further, when excimer lamps 101 having discharge gas pressures and inert gas pressures of 1.5 atmospheric pressures, 2.0 atmospheric pressures and 2.5 atmospheric pressures and having adjusted pressure differences of about 0 atmospheric pressure were obtained in the same manner as in the above procedures and caused to generate excimer rays, the discharge chambers 106 thereof caused neither cracking nor breaking.

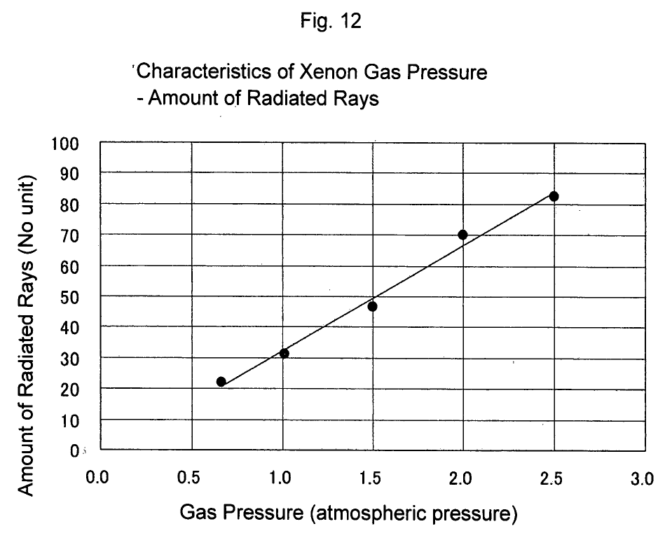

FIG. 12 shows a change in the amount of rays radiated when the pressures of the discharge gas and the inert gas were changed as described above. As shown in FIG. 12, it is seen that the radiation intensity of excimer rays can be increased by setting both the pressure of the discharge gas and the pressure of the inert gas at 1 atmospheric pressure or more.

### Example 4

### Production Example of Second Excimer Lamp

There was produced an excimer lamp 1 shown in FIG. 10 having a discharge chamber 106 having a plurality of nearly box-shaped discharge spaces arranged in parallel inside.

For producing the discharge chamber 106, first, 12 box-shaped discharge cells 125 having a longitudinal length of 150 mm, a transverse length of 100 mm and a width of 7 mm were produced with 1 mm thick synthetic quartz glass. Each discharge cell 125 internally had a hollow having a longitudinal length of 148 mm, a transverse length of 98 mm and a width of 5 mm, and these hollows were to constitute discharge spaces having a discharge channel length of 5 mm each during discharge. These 12 discharge cells were arranged in parallel such that the main surfaces thereof were opposed to one another, to obtain the discharge chamber 106. Thirteen flat-plate electrodes 105 made of aluminum having a length of 130 mm, a width of 80 mm and a thickness 1 mm each were arranged such that they were in contact with the main surfaces of the discharge cells constituting the discharge chamber 106, with one plate electrode in contact with one main surface.

As shown in FIG. 10, the discharge chamber 106 having the above plurality of arranged plate electrodes 105 was housed in a lamp chamber 104 (diameter 200 mm, height 400 mm) made of stainless steel, and a flow passage branching from a discharge gas flow passage 107 was connected to holes made on the side (upper side in Figure) opposite to optical radiation windows 123 of the discharge cells, to give a luminous unit 102. Further, each plate electrode 105 was connected to a high-frequency power source 111 provided outside the lamp chamber 104 as shown in FIG. 10.

The above lamp chamber 104 had an inert gas flow passage 109 for introducing inert gas into the lamp chamber 104 from an outside and had a circular window made of synthetic quartz having a diameter of 150 mm and a thickness of 18 mm as an optical output window 103, and the circular window was attached to the lamp chamber through a gasket.

Discharge gas (xenon gas) and inert gas (nitrogen gas), were filled in the above discharge chamber 106 and the above lamp chamber 104 in the same manner as in Example 3, to give an excimer lamp 101 in which the xenon gas and the nitrogen gas had a pressure of 2 atmospheric pressures each and the pressure difference between the two pressures was adjusted to about 0 atmospheric pressure.

When a high-frequency voltage having a frequency of 1.4 MHz and a voltage of 5.5 kVp-p was applied to the above excimer lamp 101 from a high-frequency power source 111, the discharge chamber 106 caused neither a cracking nor a breaking, and radiation rays of 500 mW/cm² could be obtained.

### INDUSTRIAL UTILITY

According to the present invention, there can be provided an excimer lamp that is enhanced in the radiation output of excimer rays and an excimer lamp that is enhanced in the radiation intensity of excimer rays while causing none of the cracking and breaking of its discharge chamber.

1.-6. (canceled)

7. An excimer lamp comprising
a luminous unit having a discharge chamber for radiating excimer rays and
a lamp chamber housing said luminous unit inside and having an optical output window provided on the exit side of radiation of rays,
wherein a discharge gas is filled in the discharge chamber of said luminous unit, an inert gas is filled between an outer wall of the discharge chamber of said luminous unit and an inner wall of said lamp chamber,
both of said discharge gas and said inert gas have a pressure of 1 atmospheric pressure or more each and are adjusted to ensure that the absolute value of a difference between these two pressures is 0.3 atmospheric pressure or less.

8. The excimer lamp as recited in claim 7, wherein said luminous unit has a discharge chamber constituted of a plurality of discharge cells arranged in parallel,
a plurality of flat-plate electrodes for excimer discharge, which are opposed to one another while being in contact with main surfaces of the discharge cells,
said discharge chamber has an optical radiation window provided in parallel with discharge channel of the discharge chamber, and
the discharge gas filled in the discharge chamber causes a discharge to radiate excimer rays.

9. The excimer lamp as recited in claim 7, wherein said discharge chamber further has discharge gas flow passage holes that go through said plurality of discharge cells.

10. The excimer lamp as recited in claim 7, wherein said luminous unit has a discharge gas flow passage for introducing discharge gas into the discharge space from the outside of the lamp chamber, and
said lamp chamber has an inert gas flow passage for introducing inert gas into the lamp chamber from the outside of the lamp chamber.
